(19) United States
(12) Patent Application Publication
(10) Pub. No.: US 2013/0218955 A1
(43) Pub. Date: Aug. 22, 2013

(54) SYSTEM AND METHOD FOR PROVIDING A VIRTUAL COLLABORATIVE ENVIRONMENT

(71) Applicant: Massachusetts lnstitute of Technology, (US)

(72) Inventors: Andy Vidan, Newton, MA (US); Paul Breimyer, Lexington, MA (US); Greggory Hogan, Stow, MA (US); Ted Roe, Boxborough, MA (US); Lester Mayer, Cambridge, MA (US); Ray DiCiaccio, Somerville, MA (US); Jared Pullen, Leominster, MA (US)

(73) Assignee: Massachusetts lnstitute of Technology, Cambridge, MA (US)

(21) Appl. No.: 13/849,804

(22) Filed: Mar. 25, 2013

Related U.S. Application Data
(63) Continuation-in-part of application No. 13/291,973, filed on Nov. 8, 2011.
(60) Provisional application No. 61/411,468, filed on Nov. 8, 2010.

(51) Int. Cl. H04L 29/08

(52) U.S. Cl. CPC H04L 67/10
USPC 709/203

(57) ABSTRACT

A system for providing a content neutral virtual collaborative environment is includes a server and a plurality of clients, including a data feed and a client device. The server is communication with the clients, and includes a memory, a processor, and a message bus configured to convey a plurality of entity messages for creating, modifying, or deleting entities. The processor is configured to convert data from clients into entity messages on the message bus. The processor parses the entity message to accordingly create, update, and/or remove entities, storing the entity message in the memory.

### CROSS-REFERENCE TO RELATED APPLICATION

This application is a continuation-in-part of copending U.S. application entitled, “SYSTEM AND METHOD FOR PROVIDING A GEO-REFERENCED VIRTUAL COLLABORATIVE ENVIRONMENT,” having Ser. No. 13/291,973, filed Nov. 8, 2011, which is entirely incorporated herein by reference, and in turn claims priority to U.S. Provisional Application entitled, “SYSTEM AND METHOD FOR PROVIDING A GEO-REFERENCED VIRTUAL COLLABORATIVE ENVIRONMENT,” having Ser. No. 61/411,468, filed Nov. 8, 2010, which is entirely incorporated herein by reference.

### STATEMENT REGARDING FEDERALLY SPONSORED RESEARCH OR DEVELOPMENT

This invention was made with government support under Contract No. FA8721-05-C-0002 awarded by the U.S. Air Force. The government has certain rights in the invention.

### FIELD OF THE INVENTION

The present invention is generally related to Internet communications, and more particularly is related to a real-time geo-referenced virtual communications.

### BACKGROUND OF THE INVENTION

Communication between a first user of a computer and a second user of a separate computer, via use of the Internet, has become more user-friendly over time. The sharing of data and images via use of the Internet is presently performed through use of one or more of many different techniques. As an example, a first user may share their computer screen with a second user located at a remote location. One program that provides this means of communication between the first and second user is GoToMeeting, by Citrix Systems, Inc.

In fact, there are many different screen-sharing programs that are presently made available to the public. While such programs provide the convenience of allowing both users to view the same screen, thereby sharing information, there are many disadvantages to screen-sharing programs. As an example, present screen-sharing programs rely upon the first user to maintain the data provided to their screen, which is shared with the remote user. If the first user does not update the data or has corrupt data, the remote user views the antiquated data or may not be able to view the data if it is corrupt. As a result, the remote user is at the mercy of the first user, the reliability of their data, and the stability of their data.

If a layer of complexity is added in which both the first user and the remote user are sharing each of their respective screens with each other, there is the added burden of maintaining data on both the computer of the first user and the computer of the remote user. This is in addition to the burden of reliability and stability of data, as previously mentioned.

Service Oriented Architectures (SOAs) have previously been used in many contexts; they have not been effective for distributed Disconnected, Intermittent and Low-bandwidth (DIL) environments. Further, under previous SOAs, such services did not scale well to provide real-time collaboration in the presence of a large number of users and divergent services.

Thus, a heretofore unaddressed need exists in the industry to address the aforementioned deficiencies and inadequacies.

### SUMMARY OF THE INVENTION

Embodiments of the present invention provide a system and method for providing an image-referenced virtual collaborative environment. Briefly described, in architecture, one embodiment of the system, among others, can be implemented as follows. The system for providing a content neutral virtual collaborative environment includes a plurality of clients, including at least one data feed, a first client device, and a second client device. The system includes a server in communication with the plurality of clients, wherein the server includes a memory, a processor, and a message bus configured to convey a plurality of entity messages. Each of the entity messages includes at least one hierarchical topic and an ordered list of at least one of a group consisting of an entity object, an update entity object, and a remove entity object. The processor is configured by the memory to perform steps including converting data from at least one of the plurality of clients into the entity object formatting a first entity message having the entity object, sending the first entity message on the message bus, receiving a second entity message on the message bus, processing the second entity message to create, update, and/or remove an entity object, and storing the entity second message in the memory.

The present invention can also be viewed as providing a method for a user to participate in a virtual collaborative environment, the environment including a server in communication with a client device, wherein the client device includes a memory and a processor configured by the memory to perform the steps of selecting a first collaboration space, interacting with at least one entity having an entity object within the collaboration space, forming a message having at least one hierarchical topic indicating the first collaboration space, and an ordered list of at least one of a group consisting of the entity object, an update entity object, and a remove entity object, and sending the message to the server.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating an exemplary network in accordance with the present system and method.

FIG. 2 is a schematic diagram illustrating a server of FIG. 1.

FIG. 3 is a flow chart providing a high-level flow of a user interacting with the present system and method.

FIG. 4 is a flow chart illustrating details and methods for how real-time, geo-referenced collaboration is achieved in accordance with the present invention.

FIG. 5 is an example of the network of a software stack of the server in accordance with an alternative embodiment of the invention.

FIG. 6 is a flow chart further describing steps taken in accordance with blocks 104 and 106 of FIG. 3.

FIG. 7 is a schematic diagram of an exemplary abstracted collaboration system.

FIG. 8 is a diagram of an exemplary entity message format used within the system of FIG. 7.

FIG. 9 is a flowchart of the interaction of a user with the system of FIG. 7.

### DETAILED DESCRIPTION

The present invention provides a system and method for use via the Internet that enables more than one user, at physically separate locations, to collaborate. In particular, users are able to conduct geo-referenced (map-centric) virtual discussions because the present system and method provides the ability to share drawings, sketches, icons, images, and other similar data on a shareable map. Users can pan and zoom to specific locations on the map, and the map of all other users will pan and zoom to the same view. Users also have the ability to see who is online and participating in a collaboration room, and to use text chatting or other communication methods within the collaboration room. Data is exchanged in real-time, including map/image interaction. Preferably, this environment is provided through the Web.

It should be noted that while the present description focuses on a map canvas (e.g., background display), and describes the technique as being “geo-referenced,” the present technology described herein can be used to collaborate around a different image (e.g., a building floor plan, an object, etc.) or even a real-time video feed. The present system and method provides the capability to spatially anchor drawings and data of a user to the canvas background and exchange these messages in real-time.

It should also be noted that while the present description refers to providing a Web application, the present system and method is not limited to being provided as a Web application stored at a server. The present description provides for software providing the functionality of the present invention to be stored on a server, with users communicating with the server from a remote location. This network configuration is not intended to be a limitation of the present invention. A different communication configuration may instead be provided, as long as multiple users may view, manipulate, and communicate regarding the same image, while using separate computers. Herein, a computer is considered to be any device having a memory and a processor that is capable of performing the functions as defined herein.

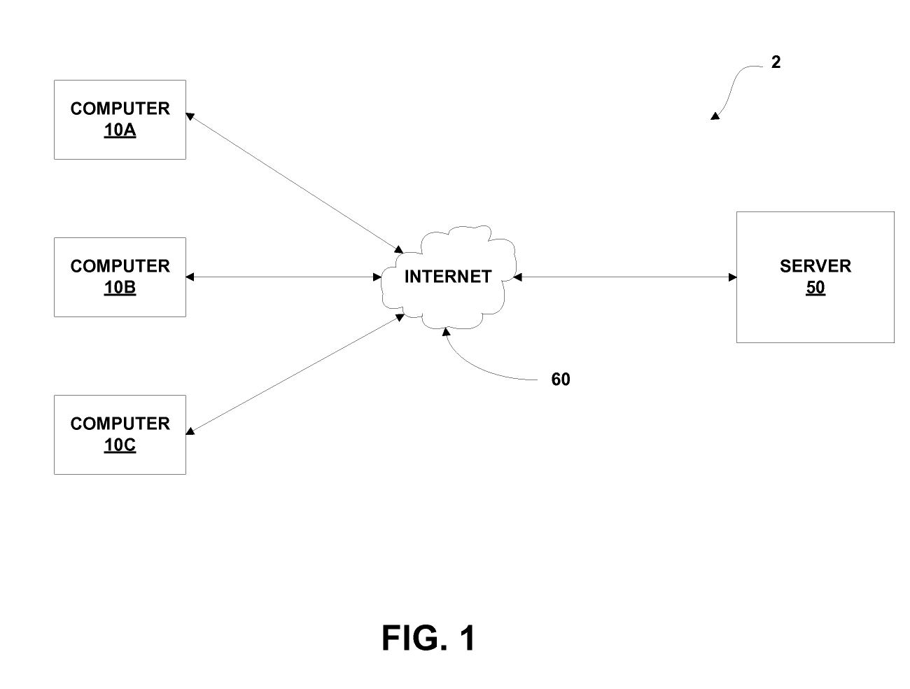

The present system and method is provided within a client/server network. FIG. 1 is a schematic diagram illustrating an exemplary network 2 in accordance with the present system and method. As shown by FIG. 1, the network 2 contains multiple computers 10A, 10B, 10C. A computer 10 may be one of many different processing devices such as, but not limited to, a general purpose standalone computer, a smart phone, or a different processing device.

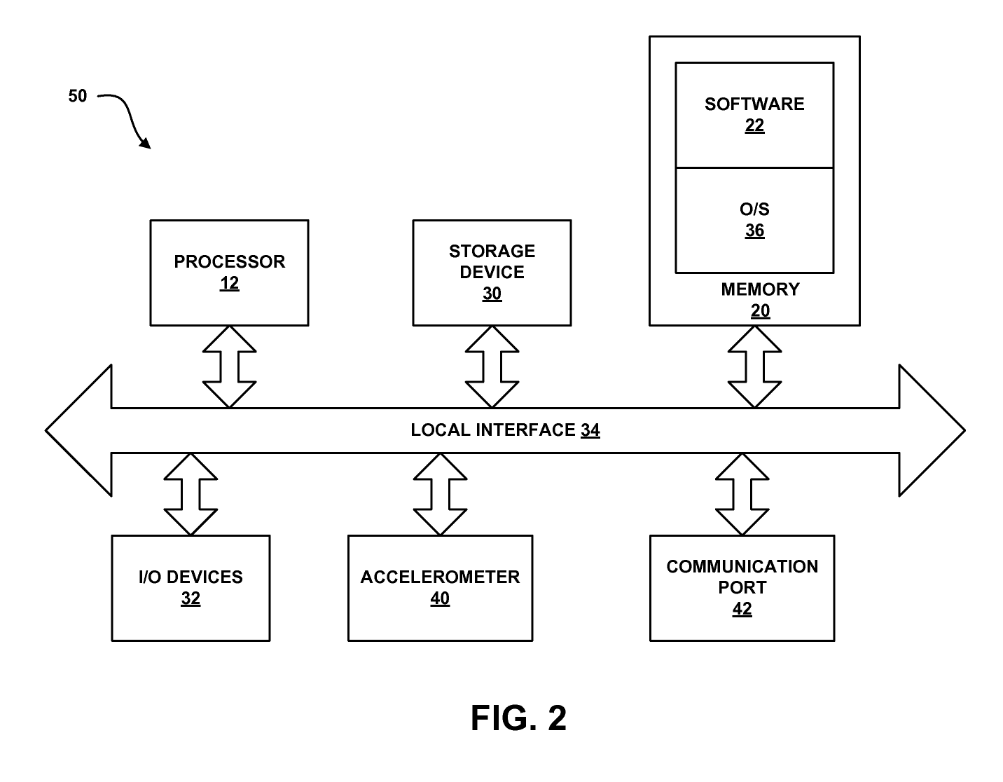

Returning to FIG. 1, the exemplary embodiment of the network 2 illustrates that each of the computers 10 communicates with a server 50. A detailed description of one example of a server 50 is provided with regard to the description of FIG. 2. The computers 10 may communicate with the server 50 via use of one or more communication protocol provided by a transmission means 60, which is known to one having ordinary skill in the art. As a non-limiting example, the computer 10 may communicate with the server 50 via the Internet 60. It should be noted that, within the network, communication may be from the computers 10 to the server 50, or from the server 50 to one or more of the computers 10.

Functionality of the server 50 can be implemented in software, firmware, hardware, or a combination thereof. In a first exemplary embodiment, a portion of the server 50 is implemented in software, as an executable program. The first exemplary embodiment of a server 50 is shown in FIG. 2. It should be noted that for simplicity, the server 50 is illustrated as having similar components to a general purpose computer.

Generally, in terms of hardware architecture, as shown in FIG. 2, the server 50 includes a processor 12, memory 20, storage device 30, and one or more input and/or output (I/O) devices 32 (or peripherals) that are communicatively coupled via a local interface 34. The local interface 34 can be, for example, but not limited to, one or more buses or other wired or wireless connections, as is known in the art. The local interface 34 may have additional elements, which are omitted for simplicity, such as controllers, buffers (caches), drivers, repeaters, and receivers, to enable communications. Further, the local interface 34 may include address, control, and/or data connections to enable appropriate communications among the aforementioned components.

The processor 12 is a hardware device for executing software, particularly that stored in the memory 20. The processor 12 can be any custom made or commercially available processor, a central processing unit (CPU), an auxiliary processor among several processors associated with the server 50, a semiconductor based microprocessor (in the form of a microchip or chip set), a macroprocessor, or generally any device for executing software instructions.

The memory 20 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 20 may incorporate electronic, magnetic, optical, and/or other types of storage media. Note that the memory 20 can have a distributed architecture, where various components are situated remote from one another, but can be accessed by the processor 12.

The software 22 in the memory 20 may include one or more separate programs, each of which contains an ordered listing of executable instructions for implementing logical functions of the server 50, as described below. In the example of FIG. 2, the software 22 in the memory 20 defines the server 50 functionality in accordance with the present invention. In addition, although not required, it is possible for the memory 20 to contain an operating system (O/S) 36. The operating system 36 essentially controls the execution of computer programs and provides scheduling, input-output control, file and data management, memory management, and communication control and related services.

The server 50 may be provided by a source program, executable program (object code), script, or any other entity containing a set of instructions to be performed. When a source program, then the program needs to be translated via a compiler, assembler, interpreter, or the like, which may or may not be included within the memory 20, so as to operate properly in connection with the O/S 36. Furthermore, the server 50 can be written as (a) an object oriented programming language, which has classes of data and methods, or (b) a procedure programming language, which has routines, subroutines, and/or functions.

The I/O devices 32 may include input devices, for example but not limited to, a touch screen, a keyboard, mouse, scanner, microphone, or other input device. Furthermore, the I/O devices 32 may also include output devices, for example but not limited to, a display, or other output devices. The I/O devices 32 may further include devices that communicate via both inputs and outputs, for instance but not limited to, a modulator/demodulator (modem; for accessing another device, system, or network), a radio frequency (RF), wireless, or other transceiver, a telephonic interface, a bridge, a router, or other devices that function both as an input and an output. I/O devices 32 are used to transmit the smart messages from the vehicle to the server 50.

When the server 50 is in operation, the processor 12 is configured to execute the software 22 stored within the memory 20, to communicate data to and from the memory 20, and to generally control operations of the server 50 pursuant to the software 22. The software 22 and the O/S 36, in whole or in part, but typically the latter, are read by the processor 12, perhaps buffered within the processor 12, and then executed.

When the server 50 is implemented in software, as is shown in FIG. 2, it should be noted that the server 50 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The server 50 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The storage device 30 of the server 50 may be one of many different types of storage device, including a stationary storage device or portable storage device. As an example, the storage device 30 may be a magnetic tape, disk, flash memory, volatile memory, or a different storage device. In addition, the storage device may be a secure digital memory card or any other removable storage device 30. In addition, as is typical with most servers, there may be more than one storage device within the server 50.

The following flow charts further describe how the present system and method is able to achieve real-time, geo-referenced (e.g., spatially anchored) collaboration. It should be noted that any process descriptions or blocks in flow charts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

It should be noted that, at each computer 10, there is no need for any proprietary software or hardware to use the technology of the present system and method. In addition, no specific operating system is required. Users only need to possess a compatible Web browser and an Internet connection (wired or wireless). Users can use this technology on workstations, laptops, and any other Web enabled devices (e.g., smartphones, etc.).

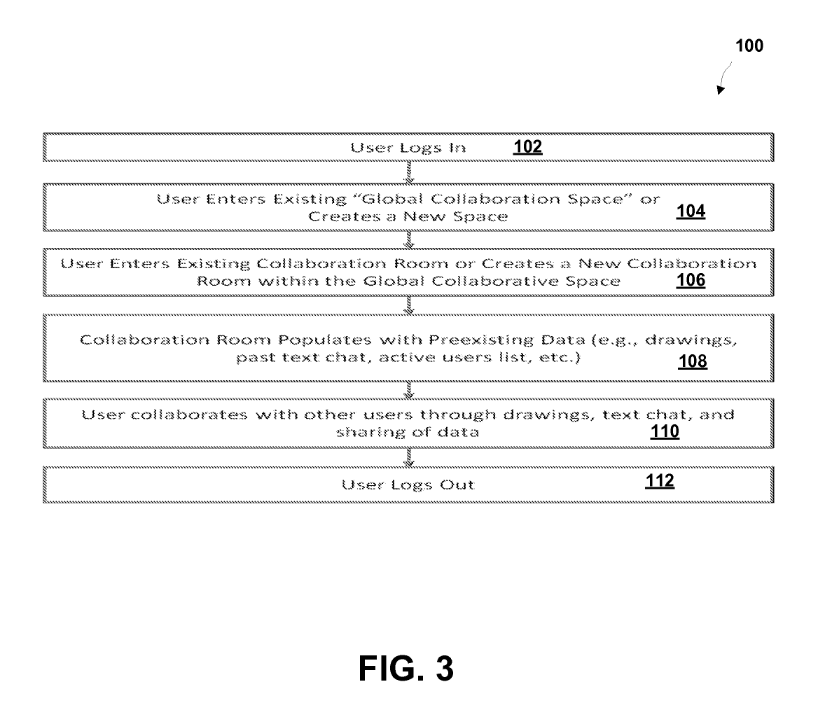

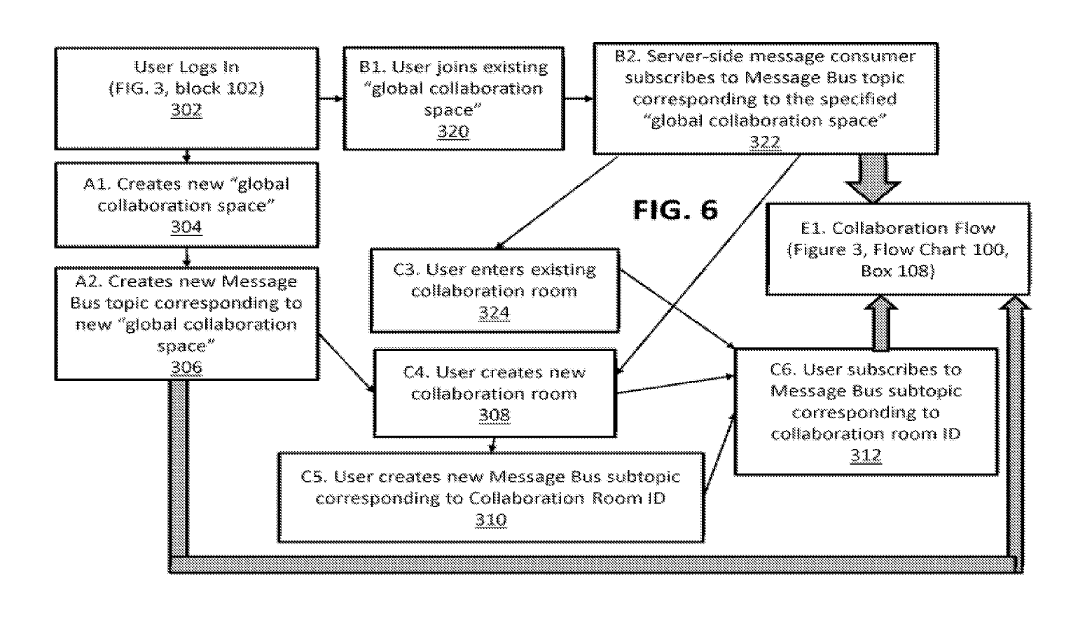

FIG. 3 is a flow chart 100 providing a high-level flow of a user interacting with the present system and method. As shown by block 102, a user logs into the server 50 to use the present system. As an example, a user may log into a Web site via his/her computer 10. The user then enters an existing global collaboration space or creates a new global collaboration space (block 104). As an example, a global collaboration space may be defined by a subject matter, with an associated portion of a background image associated with the subject matter. For example, a subject matter might be “Haiti Disaster” and the background image may be a map of the world associated with the Haiti Disaster. As shown by block 106, the user then either enters an existing collaboration room or creates a new collaboration room within the global collaborative space. FIG. 6 is a flow chart further describing steps taken in accordance with blocks 104 and 106.

Returning to FIG. 3, the collaboration room then populates with preexisting data, such as, but not limited to, drawings, past text chat, an active users list, or other preexisting data (block 108). As shown by block 110, the user then collaborates with other users through drawings, text chat, sharing of data, or other means of collaboration. The user may then log out (block 112).

The global collaboration spaces and collaboration rooms are created through use of unique message bus topics and the persisting of related data to a database, with use of a header identifying any global collaboration space name and/or collaboration room name. Any user can register a new global collaboration space or collaboration room; the process merely requires a unique name to be given to the collaboration space or collaboration room. To create a new global collaboration space, when instructed to do so by the user, the server 50 creates a new message bus topic on the server 50 with the name corresponding to the new global collaboration space, as provided by the user.

When a new collaboration space or collaboration room is created, information such as the topic name and subtopic name is persisted, which can then be used to reconstruct the unique topic that belongs to the collaboration space or collaboration room for rendering on the screen of a second user located separate from the first user. At the same time as the registration of the collaboration room or collaboration space completes, the user is subscribed to the corresponding topic on the message bus, thus creating a virtual, sandboxed area within the message bus for the collaboration space or data of the collaboration room. When new users want to join the new collaboration space or collaboration room, they simply look up the names of collaboration spaces and/or rooms, and choose which to join. The database lookup allows retrieving of the unique topic and subscribing the user to the topic, thus bringing the user into the new collaboration space or collaboration room. Specifically, after a user has created a new collaboration space and provided an associated name, the name may be searched by other users of the present system and method.

It should be noted that the present description uses the relationship of a global collaboration space having a topic name, while a collaboration room has a subtopic name. In addition, as is explained in further detail herein, massages transmitted by users within a collaboration space or collaboration room are transmitted with a header. Specifically, messages transmitted within a global collaboration space contain a header and a payload. For identification purposes, the header contains the topic name and the subtopic name, while the payload contains the data being transmitted, such as, but not limited to, encoded vectors for rendering of vector objects.

Actions between the user (“Client”) and server may be passed in messages on the message bus. Since one having ordinary skill in the art would know what a message bus is and that it is used in publish/subscribe messaging, a detailed description of the same is not provided herein. As one example, the Advanced Message Queuing Protocol, an Open Standard for Messaging Middleware, may be used. The present use of message bus topics allows information to be sandboxed according to the “global” collaboration spaces and rooms. The topic is essentially the “address” to which a message is sent. Only users who have subscribed to a particular topic can retrieve the messages sent to the topic. As each space or room is given a unique identifier (e.g., name), that identifier can be used to constrain the distribution of the information generated in the space or room. Thus, all information generated and shared in the “global” collaboration space will be shared with only the users currently in that space, and likewise for the individual collaboration rooms.

### Client-Server Communication for Message Bus Interaction

In order to allow the client to be free of any proprietary software necessarily being installed on an associated computer 10, communication from the client to the message bus must be proxied through the server 50. Normally an application connecting to the message bus would communicate directly to the message bus via a message bus end-client. However, this would require specialized software to be placed on the client machine (e.g., computer 10). So instead, within the code running in the Web Browser, a proxy is set up that makes HTTP calls to a component on the server 50. The interaction between the proxy and server-side component is facilitated through a process known as “remoting” implemented in the Seam Remoting library. A proxy is created for both the “consumer” and the “producer” components. When a client wants to send a message onto the message bus, it uses the “producer” proxy, which triggers a server-side component to execute its “send” method, which places the specified message onto the message Bus. Similarly, for retrieving messages from the message bus, there is a server-side component. This “consumer” component receives any messages intended for the client and stores them in memory. When the client wants to retrieve these messages, it uses the “consumer” proxy component to execute the server-side component's “retrieve” method, which returns all stored messages to the client. Then the stored messages are cleared from memory, and the server-side component begins storing new incoming messages for the client.

FIG. 6 is a flow chart 300 further describing steps taken in accordance with blocks 104 and 106, specifically, the creating and/or joining of global collaboration spaces and/or rooms. As shown by block 302, the user logs into the server. Block 302 corresponds to block 102 of FIG. 3. The creation of a new global collaboration space is the A route illustrated by FIG. 6, while the joining of an existing global collaboration space is the B route. If the user chooses to create a new global collaboration space (block 304), the user provides the server 50 with a new message bus topic corresponding to the new global collaboration space, which will be used to identify the new global collaboration space (block 306). Messages (i.e., information) shared within the new global collaboration space would only be distributed among users subscribed to the topic identifying the new global collaboration space.

The user may then create a collaboration room within the global collaboration space (block 308). During creation of a new collaboration room, the user creates a new massage bus subtopic corresponding to the collaboration room identification (block 310). The user is then subscribed to the message bus subtopic corresponding to the collaboration room identification (block 312). Messages (i.e., information) shared within the new collaboration room are only distributed among users subscribed to the collaboration room subtopic.

Instead of creating a new global collaboration space, a user may select to join an existing global collaboration space (block 320). If the user selects to join an existing global collaboration space, such as by selecting a space from a list provided to the user for selection, the server-side message consumer subscribes to the message bus topic corresponding to the specified global collaboration space (block 322). Messages (i.e., information) shared in the global collaborative space is only distributed among users subscribed to the topic.

The user may then either select to enter an existing collaboration room (block 324) or create a new collaboration room (block 308—previously described). If the user selects to enter an existing collaboration room, such as by selecting a room from a list provided to the user for selection, the user is then subscribed to the message bus subtopic corresponding to the collaboration room identification (block 312). Blocks 312 and 322 continue with block 108 of the flow chart of FIG. 3.

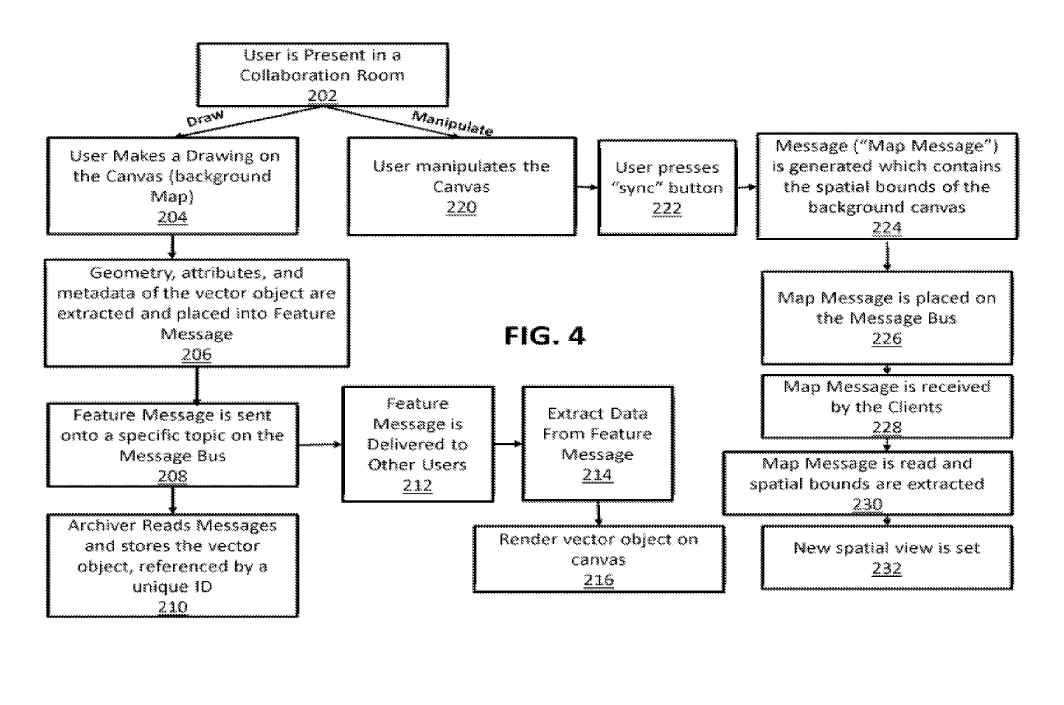

FIG. 4 is a flow chart 200 illustrating details and methods for how real-time, geo-referenced collaboration is achieved in accordance with the present invention. Once in a collaboration room (block 202), a user can either send text chats, or draw or manipulate a background canvas (e.g., map or image). The following provides details regarding how drawing and manipulation is handled by the present invention.

It should be noted that the background canvas may be previously stored on the server 50 and selectable by the user for use in accordance with the present invention. Upon selection, the user may associate the background canvas with a specific global collaboration space and/or collaboration room. Alternatively, the user may select to upload a background canvas to the server 50 for association with a specific global collaboration space and/or collaboration room.

As shown by FIG. 4, the user is present in a collaboration room (block 202). For drawing, as shown by block 204, the user makes a drawing on the canvas (background map). The drawing is a vector object with a given geometry, attributes, and metadata.

Geometry, attributes, and metadata of the vector object are extracted and placed into a message, referred to herein as a feature message (block 206). It should be noted that the feature message contains the header and payload as previously described. As previously mentioned, the header contains the topic name and the subtopic name, while the payload contains the data being transmitted. Herein, geometry, attributes, and metadata of the vector object are also referred to as properties of the vector object. An example of how to create a feature message includes the following steps: 1) using a software library for displaying maps (for example, OpenLayers), a vector object is drawn on the map; 2) add a number of properties to the vector object, which store style information and other metadata; 3) the vector object contains geometry data, which may be written to a “Well Known Text” (WKT) string; 4) within the feature message (which, for example, may be created as a Javascript object and then transformed into a JavaScript Object Notation (JSON) string), add a field that contains the WKT string (i.e., the feature's geometry in string form) and a field listing the metadata of the vector object (this contains styling info for example); and 5) once the Javascript object is converted to a JSON string, send it out onto the message bus.

As shown by FIG. 4, the feature message is then sent onto a specific topic on the message bus (block 208). An archiver then reads messages and stores the vector object, references by a unique ID (block 210). Reading a feature message includes the following steps: 1) parse the JSON string message back into a Javascript object; 2) geometry data is stored as a WKT string, which is a standard format, so one can easily convert this string into a geometry object that OpenLayers can use to draw the feature; 3) create an OpenLayers feature using the geometry object from above and the attributes that are stored in our feature message; and 4) draw this feature on the map, using the OpenLayers library.

As shown by block 212, the feature message is delivered to other users. Data is then extracted from the feature message (block 214). The vector object is then rendered on the canvas (block 216).

For manipulating the canvas, as shown by block 220, the user manipulates the canvas (e.g., pans/zooms the map to a specific location). The user selects a “sync” button (block 222). A message is then generated (referred to as a “map message”), which contains the spatial bounds of the background canvas (block 224). To create the map message, the following steps are performed: 1) when the user clicks the Map Sync button, capture the geographic bounds of the current window using OpenLayers functions; and 2) add these bounds as a string to the map message and send it out on the message bus.

The map message is then placed on the message bus (block 226), after which the map message is received by the clients (block 228). As shown by block 230, the map message is then read and spatial bounds are extracted. Reading of a map message is performed by the following steps of: 1) reading in the map message and obtaining geographic bounds as a string from the message; and 2) using OpenLayers functions, setting the bounds of the map of the user to the bounds described by the string. The new spatial view is then set (block 232).

In order for the various messages (e.g., presence message, feature message and map message) to be sent to only those users subscribed and present in the particular collaboration rooms, the following exemplifies a hierarchy of topics that may be used on the message bus.

### Topic/Sub-Topic Organization of the Message Bus

```
• Top Hierarchy
      ∘ ctrl [for system-wide control messages]
      ∘ alert [for system-wide alert messages]
          • email [for email alert messages]
          • sadisplay [for alert messages designated for
              sadisplay consumption]
      ∘ incidents [incidents namespace]
          • <incident-name> [sub-topic for each specific
              incident]
                • other [for non-collaboration,
                  incident-wide messages, such as incident
                  status reports]
                    ∘ roc [report on conditions
                      messages]
                    ∘ resource [resources messages]
                • collab [collaboration namespace]
                    ∘ <room-name> [sub-topic for each
                      collaboration room within an
                      incident]
      ∘ noincident [namespace for messaging when users have
          no incident selected]
          • other [for non-collaboration messages to be
              sent out to all users not within an incident]
                • roc [report on conditions messages]
                • resource [resources messages]
          • collab [collaboration namespace]
                • <room-name> [sub-topic for each
                  collaboration room without an incident]
```

For example, if a user is in the “LLTest” Collaboration Room, the Client will be listening for messages in the “LLTest” Collaboration Room within the “LLTestIncident” global Collaborative Space, and the routing pattern would be “LDDRS.incidents.LLTestIncident.collab.LLTest”.

The following provides an example of a feature message.

### Example Feature Message:

```
{
“feat”:
        {
        “id”:<id_string>,
        “from”:
                        {
                        “user”:<user_string>,
                        “nick”:<nickname_string>
                        },
        “type”:<feature_command_type>,
        “content”: <command_string> || <packed_feature> ||
<attributes_object> || null
        },
“room”:<room/topic_string>,
“time”:<date_string>,
“ver”:<version_number: major.minor.revision>,
“ip”:<ip_address>,
“seqtime”:<long, auto-generated>,
“seqnum”:<integer, auto-generated>,
“topic”:<string, full topic pattern>
}
<feature_command_type> = ‘move’ || ‘draw’ || ‘remove’ ||
‘modify’
<command_string> = the move instructions -- a string
representing the lat and lng
<packed_feature> = a packed version of the feature, as
follows:
        {
        “attrs”: an object containing name-value pairs for
feature attributes, such as styling attrs, creator attr,
timestamp, etc
        “geo”: a stringified version of the features
geometry, created by a call to
Feature.Geometry.toString( );
        }
<attributes_object> = an object containing key-value
pairs that correspond to properties of the
feature.attributes object
```

The following provides an example of a feature draw massage.

### Example Feature Draw Message

```
{
“feat”:
        {
        “id”:“OpenLayers.Feature.Vector_6702admin”,
        “from”:{“user”:“admin”,“nick”:“admin”},
        “type”:“draw”,
        “content”:
                {
                “attrs”:
                        {
                        “type”:“polygon”,
                        “created”:“2010031613:42:05”,
                        “eventname”:“default”,
                        “user”:“admin”,
                        “opacity”:0.4,
                        “strokeWidth”:“2”,
                        “dashStyle”:“solid”,
                        “strokeColor”:“#FF0000”,
                        “fillColor”:“#FF0000”,
                        “pointRadius”:2,
                        “hasGraphic”:false,
                        “graphic”:“”,
                        “graphicWidth”:0,
                        “graphicHeight”:0,
                        “labelText”:“”
                        },
                “geo”:“POLYGON((−13050858.207594
4016842.2728551,−13050934.644623 4016460.0877138,−
13051087.518679 4016077.9025724,
−13051240.392736 4016001.4655441,−13051240.392736
4015772.1544593,−13051240.392736 4015619.2804028,−
13051240.392736 4015466.4063462,
−13051163.955707 4015389.9693179,−13051087.518679
4015313.5322897,−13050934.644623 4015313.5322897,−
13050781.770566 4015313.5322897,
−13050476.022453 4015313.5322897,−13049940.963255
4015466.4063462,−13049635.215142 4015542.8433745,−
13049329.467029 4015619.2804028,
−13049100.155944 4015772.1544593,−13048947.281887
4015772.1544593,−13048947.281887 4015848.5914876,−
13048947.281887 4015925.0285159,
−13049100.155944 4015925.0285159,−13049176.592972
4016077.9025724,−13049253.030001 4016154.3396007,−
13049329.467029 4016307.2136572,
−13050858.207594 4016842.2728551))”
                }
        },
“room”:“TestIncident-test_room1”,
“time”:“2010-16-03 17:29:05”,
“ver”:“1.0.1”,
“ip”:“127.0.0.1”,
“seqtime”:1281638761157,
“seqnum”:327,
“topic”:“LDDRS.incidents.TestIncident.collab.test_room1”
}
```

The following provides an example of a feature move message.

### Example Feature Move Message

```
{
“feat”:
        {
        “id”:“OpenLayers.Feature.Vector_294admin”,
        “from”:
                {
                “user”:“admin”,
                “nick”:“admin”
                },
        “type”:“move”,
        “content”:“−13055291.555234, 4001401.9931437”
        },
“room”:“TestIncident-test_room1”,
“time”:“2010-16-03 17:29:05”,
“ver”:“1.0.1”,
“ip”:“127.0.0.1”,
“seqtime”:1281638761157,
“seqnum”:327,
“topic”:“LDDRS.incidents.TestIncident.collab.test_room1”
}
```

The following provides an example of a feature delete message.

### Example Feature Delete Message

```
{
“feat”:
        {
        “id”:“OpenLayers.Feature.Vector_465admin”,
        “from”:
                {
                “user”:“admin”,
                “nick”:“admin”
                },
        “type”:“remove”,
        “content”:null
        },
“room”:“TestIncident-test_room1”,
“time”:“2010-16-03 17:29:05”,
“ver”:“1.0.1”,
“ip”:“127.0.0.1”,
“seqtime”:1281638761157,
“seqnum”:327,
“topic”:“LDDRS.incidents.TestIncident.collab.test_room1”
}
```

The following provides an example of a feature modify message.

### Example Feature Modify Message

```
{
“feat”:
        {
        “id”:“OpenLayers.Feature.Vector_465admin”,
        “from”:
                {
                “user”:“admin”,
                “nick”:“admin”
                ),
        “type”:“modify”,
        “content”:
                (
                “rotation”:45
                }
        },
“room”:“TestIncident-test_room1”,
“time”:“2010-16-03 17:29:05”,
“ver”:“1.0.1”,
“ip”:“127.0.0.1”,
“seqtime”:1281638761157,
“seqnum”:327,
“topic”:“LDDRS.incidents.TestIncident.collab.test_room1”
}
```

The following provides an example of a message to sync map canvas views.

### Example Message to Sync Map Canvas Views

```
{
“map”:
        {
        “from”:
                {
                “user”:<user_string>,
                “nick”:<nickname_string>
                },
        “bounds”:<bounds_string>,
        “proj”:<proj_code_string>
        }
“room”: <room/topic_string>,
“time”: <date_string>,
“ver”:<version_number: major.minor.revision>,
“ip”:<ip_address>
}
e.g.
{
“map”:
        {
        “from”:
                {
                “user”:“admin”,
                “nick”:“admin”
                },
        “bounds”:“−13168724.105188, 3818488.1844849,
924737.110946, 3947513.8882071”,
        “proj”:“EPSG:900913”
        }
“room”: “TestIncident-testroom”,
“time”: “2010-16-03 17:29:05”,
“ver”:“1.0.1”,
“ip”:“127.0.0.1”,
“seqtime”:1281638761157,
“seqnum”:327,
“topic”:“LDDRS.incidents.TestIncident.collab.test_room1”
}
```

The following provides an example of a chat message for text chatting.

### Example Chat Message for Text Chatting

```
{
“msg”:
        {
        “id”:<id_number>,
        “from”:
                {
                “user”:<user_string>,
                “nick”:<nickname_string>,
                “org”:<organization_string>
                },
        “body”:<body_string>
        },
“room”:<room/topic_identifier>,
“time”:<date_string>,
“ver”:<version_number: major.minor.revision>,
“ip”:<ip_address>,
“seqtime”:<long, auto-generated>,
“seqnum”:<integer, auto-generated>,
“topic”:<string, full topic pattern>
}
e.g.
{
“msg”:
        {
        “id”:13564897546478,
        “from”:
                {
                “user”:“admin”,
                “nick”:“admin”,
                “org”:“MITLL”
                },
        “body”:“still getting my messages?”
        },
“room”:“TestIncident-test_room1”,
“time”:“2010-16-03 17:29:05”,
“ver”:“1.0.1”,
“ip:”:“127.0.0.1”,
“seqtime”:1281638761157,
“seqnum”:327,
“topic”:“LDDRS.incidents.TestIncident.collab.test_room1”
}
```

### Presence Message

The following is an example of a presence message, sent by the Client to inform other users when a user's presence in a collaboration room changes.

```
{
    “pres”:{
        “type”:<presence_type>,
        “states”:{
            <username>:{
                “state”:<state>,
                “metadata”:{
                    <field>:<value>,
                    ...
                }
            },
          ...
        }
    },
    “user”:“collabmanagercomp”,
    “room”:<room/topic_identifier>,
    “time”:<date_string>,
    “ver”:<version_number:major.minor.revision>,
    “ip”:<ip_address>,
    “seqtime”:<long, auto-generated>,
    “seqnum”:<integer, auto-generated>,
    “topic”:<string, full topic pattern>
}
where <presence_type> = “diff” || “full” (indicating
whether this is a complete view of the room state or just
a diff from the previous diff view)
e.g.
{
    “pres”:{
        “type”:“diff”,
        “states”:{
            “rayd”:{
                “state”:“active”,
                “metadata”:{
                    “org”:“MITLL”,
                    ...
                }
            },
            “pbreimyer”:{
                “state”:“active”
            }
        }
    },
    “user”:“collabmanagercomp”,
    “room”:“TestIncident-test_room1”,
    “time”:“2010-16-0317:29:05”,
    “ver”:“1.0.2”,
    “ip”:“127.0.0.1”,
    “seqtime”:1281638761157,
    “seqnum”:327,
“topic”:“LDDRS.incidents.TestIncident.collab.test_room1”
}
metadata should be as follows (subject to change):
{
    “org”:“MITLL”,
    “firstname”:“Ray”,
    “lastname”:“Di Ciaccio”
}
```

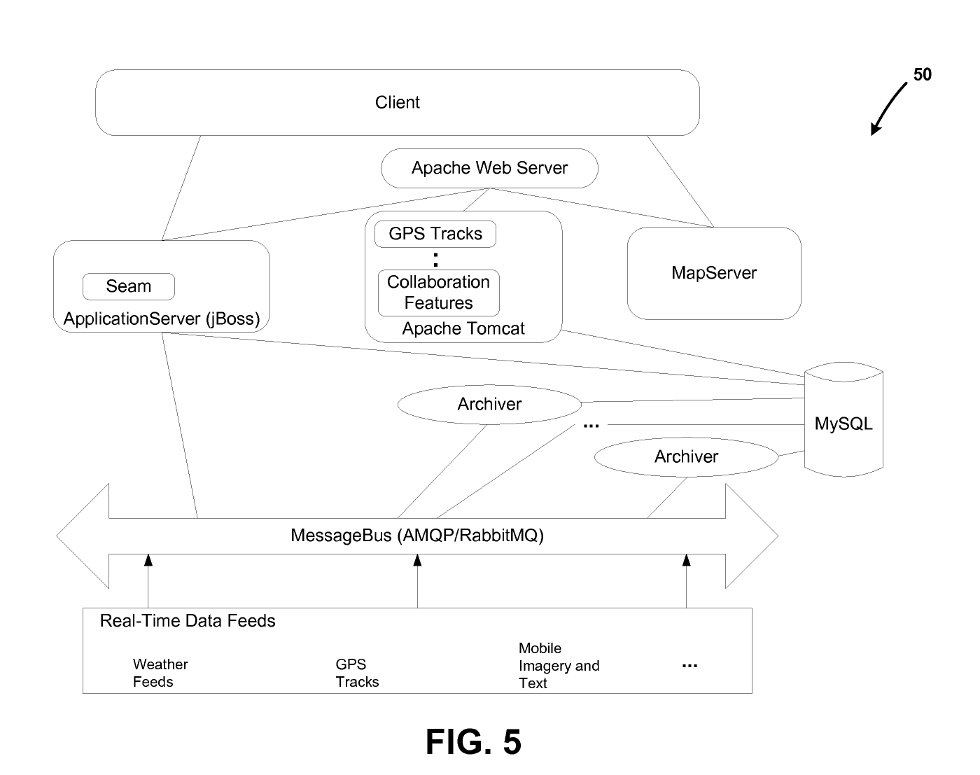

FIG. 5 is an example of the network of a software stack of the server 50 in accordance with an alternative embodiment of the invention. FIG. 5 shows one potential software stack that can be used to implement this invention, while many others may be used. The “producer” and “consumer” proxies are implemented as Java Beans running in the Application Server (see FIG. 5). The client 500, or web browser, makes an HTTP request to use either the “producer” or “consumer” through the Apache Web Server, which directs the request to the JBoss Application Server (AS). The AS handles this request in the context of the inventive web-application, which is using the Seam Remoting Application Programming Interface (API). The Seam Remoting API interprets the request and calls the corresponding method on the specified Java Bean. Both the “producer” and “consumer” Java Beans are connected to the message bus and interact with it directly, either sending or retrieving messages based on the type of request from the client. In this way, a message passes from the client, to the “producer” Java Bean running within the AS, and out onto the Message Bus; or in the reverse direction, it passes from the Message Bus, into the “consumer” Java Bean running within the AS, and back to the Client.

Abstraction

While the preceding discussion describes embodiments of a system for providing a geo-referenced virtual collaborative environment with specific applications in mind, the system may be abstracted as a generalized collaboration space system for an unspecified application. Such an abstraction may provide a flexible framework for incorporating new applications into an existing system, and provide scalability features as the number of users and applications grow over time. Users of the abstracted system may create, edit and remove “entities” within the collaboration space, where the entities may differ depending upon the application. For example, in a first application, entities may relate to maps and map features, while in a second application entities may relate to videos and video features.

An entity may be a software object, for example, an instantiation of a software class. An entity may contain parameters and/or fields that identify what the entity is, as well as the current state of the entity. An entity may have a limited scope, for example, only visible to subscribers of a collaborated space, or “topic.” Other entities may be visible across two or more collaborated spaces.

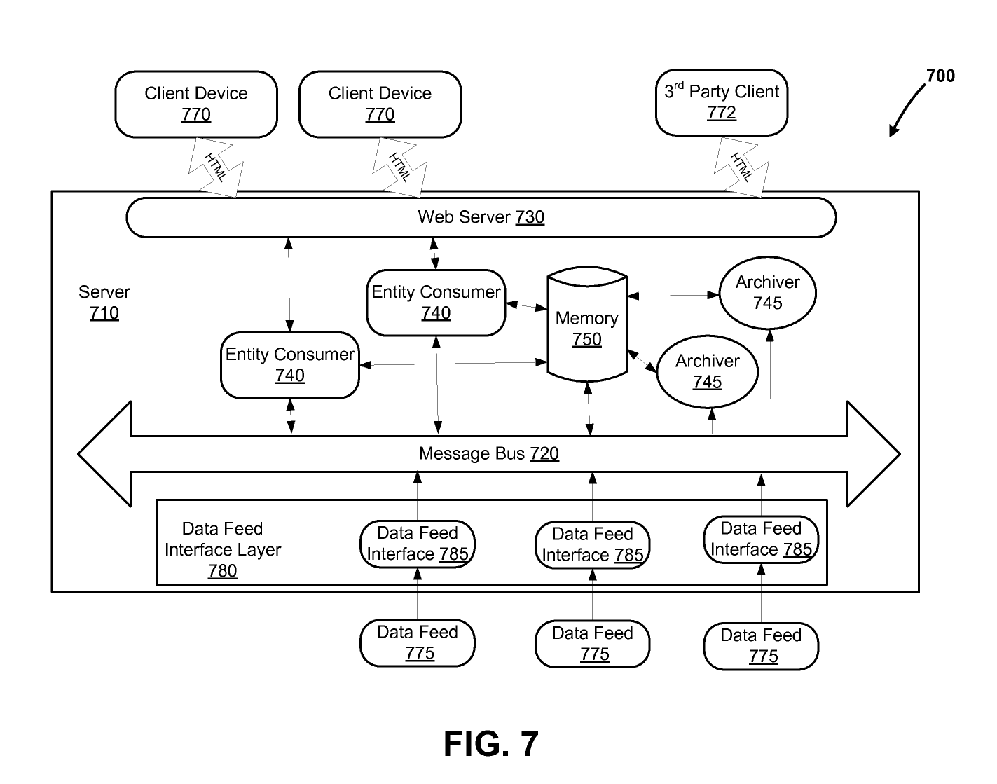

As shown by FIG. 7, the technology described above may be abstracted as an exemplary embodiment of a system 700 that enables multiple users, via client devices 770 at physically separated locations, to collaborate using new web technologies. Users may conduct virtual discussions by creating modifying and deleting virtual entities. Entities are data concepts with a consistent encapsulating representation for handling across, for example, Service Oriented Architecture (SOA) services. Examples include a feature message, a report, and a user status, among others.

The entity may encapsulate a broad range of data types, such that the system wide handling of information is broadly consistent regardless of the specific data or end application. The collaboration space itself may be treated as an entity that may be created, modified and deleted. Collaboration spaces may be organized using a topic hierarchy that separates a global collaboration space from individual collaboration spaces or rooms. In this way, a collaboration space may hierarchically contain other entities, and the contained entities may themselves be collaboration spaces, or other entities that users may create, modify and remove within the containing collaboration space. Information may be exchanged in real-time and may be archived to persist in a database for later retrieval.

The system may be visualized as a server-client model, where clients are in communication with a server 710, and clients are largely divided into data feeds 775 and client devices 770. In general, a data feed 775 transmits and/or streams data of various types and/or formats into a data feed interface layer 780 within the server 710, where the data feed interface layer 780 includes at least one data feed interface 785. The data feed interface layer 780 may include a single data feed interface 785 or multiple data feed interfaces 785, for example, one data feed interface 785 for each data feed 775.

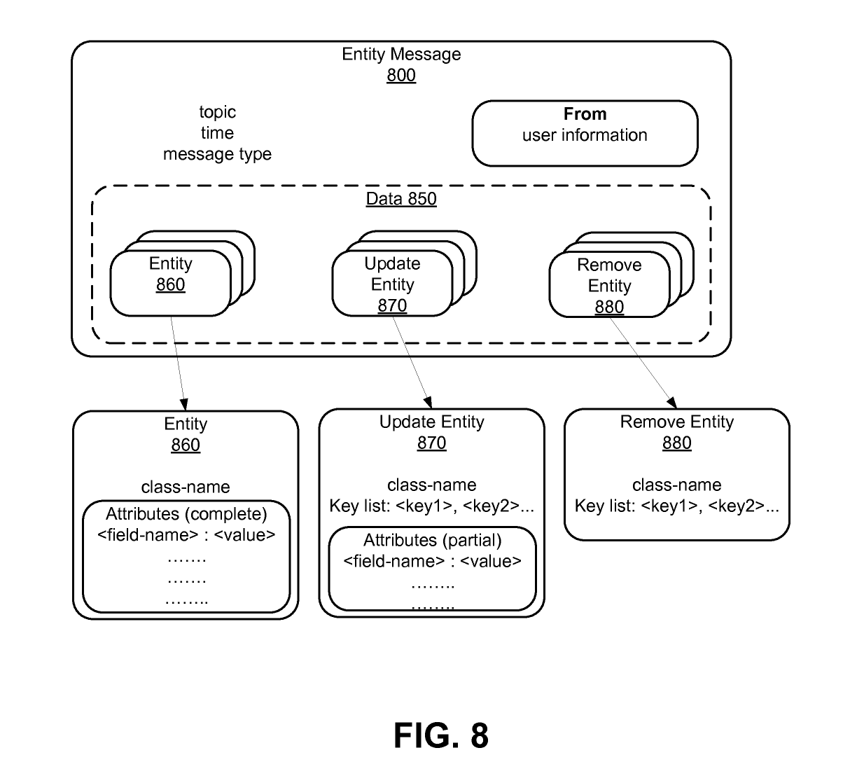

Each data feed interface 785 receives data from one or more data feed 775 and packages the data from the data feed as an entity object that may be conveyed within the server 710 as an entity message 800 (FIG. 8) via a message bus 720. The data feed interface 785 may convert the data received on the data feed 775 from an external data format to a data format recognized by entity consumer 740 within the server 710. For example, a data feed interface 785 may convert a word processing file using a proprietary file format received on a data feed 775 and convert the word processing file to a text entity object that may be recognized by one or more entity consumers 740 within the server 710. Of course, other types of data may be converted by data feed interfaces 785, such as audio data, video files, chat messages, email, image files, and others.

The data on the data feeds 775 may be received as separate files or packets, or may be received as a continuous stream that the data feed interfaces 785 partition into individual entity messages 800 (FIG. 8). In general, each data feed interface 785 is configured to accept and process one or more specific data formats, converting the data received from the data feed 775 to an entity message 800 (FIG. 8).

FIG. 8 shows the structure of an exemplary entity message 800. An entity message 800 is a message wrapper for sharing of entities. An entity message 800 contains an ordered list of up to three types of data 850, including an entity object 860 for creating a new entity, an update entity object 870 for modifying an existing entity, and a remove entity object 880 for deleting an existing entity. Each of these data types is described further below.

Each entity message 800 must contain at least one of an entity object 860 or an update entity object 870 or a remove entity object 880. An entity message 800 may contain more that one of an entity object 860 or an update entity object 870 or a remove entity object 880, or any combination of entity objects 860, update entity objects 870, and/or remove entity objects 880.

The entity object 860 is used to create a new entity. The entity object 860 describes a complete entity with all attributes needed to define the entity. The update entity object 870 contains a unique identifier of an entity to be modified, and at least one attribute of the entity to be modified. The attribute may be represented as, for example, an attribute ID paired with a value for the attribute corresponding to the attribute ID. The new attribute value may be used to replace an old attribute value in the identified entity. A remove entity object 880 contains one or more entity identifiers specifying one or more entities to be removed. No additional attributes are needed.

Returning to FIG. 7, entity messages 800 (FIG. 8) may be processed by entity consumers 740. An entity message parser works abstractly using reflection to build and update entity objects from entity messages 800 (FIG. 8). In general entity consumers 740 may operate on any type of entity object. However, sometimes it is advantageous to provide an entity specific entity consumer 740, such that an entity message parser passes an entity object to an extended entity processor configured to process a specific subset of entity object types, or even a single entity object type. For example, a move process may process feature entities, and a re-order process may process entities that maintain in a relative order, such as folder and datalayer entities. The entity message model may be used to collaborate and/or persist any entity defined in a software class that implements the appropriate interfaces.

The server 710 includes one or more entity consumers 740. An entity consumer 740 may be a process or a processor configured to monitor the message bus 720 for entity messages 800 (FIG. 8). An entity consumer 740 may process all entity messages 800 (FIG. 8), or may selectively process only specific types of entities. An entity consumer 740 may be configured to process one or more types of entity messages 800 (FIG. 8). An entity consumer 740 may communicate with the memory 750. For example, the entity consumer 740 may access entity messages 800 (FIG. 8) that have been stored in the memory 750. Entity consumers 740 may also receive entity messages 800 (FIG. 8) from a web server 730, described further below.

The server 710 includes one or more message archivers 745. The message archiver 745 is a type of entity consumer 740 that monitors the message bus 720 for entity messages 800 (FIG. 8) and stores the entity messages 800 (FIG. 8) in the memory 750, for example, for cataloging and playback. A particular message archiver 745 may be configured to monitor for one or more specific types of entity messages 800 (FIG. 8), and ignore all other entity messages 800 (FIG. 8). For example, a first archiver 745 may be configured to archive all entity messages 800 (FIG. 8) on the message bus 720 that contain video data, and a second archiver 745 may be configured to archive all entity messages 800 (FIG. 8) on the message bus 720 that include chat data. A default archiver 745 may serve as a catch-all archiver, and store any entity messages 800 (FIG. 8) in the memory 750 that all other archivers 745 are not configured to process. In alternative embodiments, a system 700 may have a single message archiver 745 for archiving all entity messages 800 (FIG. 8).

As discussed above regarding the memory 20 (FIG. 2), the memory 750 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 750 may incorporate electronic, magnetic, optical, and/or other types of storage media. The memory 750 can have a distributed architecture, where various components are situated remote from one another. The memory 750 may contain multiple types of data, for example, code executable by the entity consumers 740 and archivers 745, entity messages 800 (FIG. 8), and entity objects, amongst other data.

It should be noted that data of an unknown or unrecognized format may be processed by a default data feed interface 785 that encapsulates the data as an entity message 800 (FIG. 8), where the server 710 may then process the entity message as any other entity message. For example, a catch-all archive process may store such entity messages.

The Server 710 may also include a web server 730. The web server 730 provides an interface for the server 710 to communicate with HTML clients such as client devices 770 and one or more third party clients 772. An examples of third party clients 772 includes a web site, such as Google. The server 710 may format data from a third party client as an entity message 800 (FIG. 8) for transport on the message bus 720, described further below.

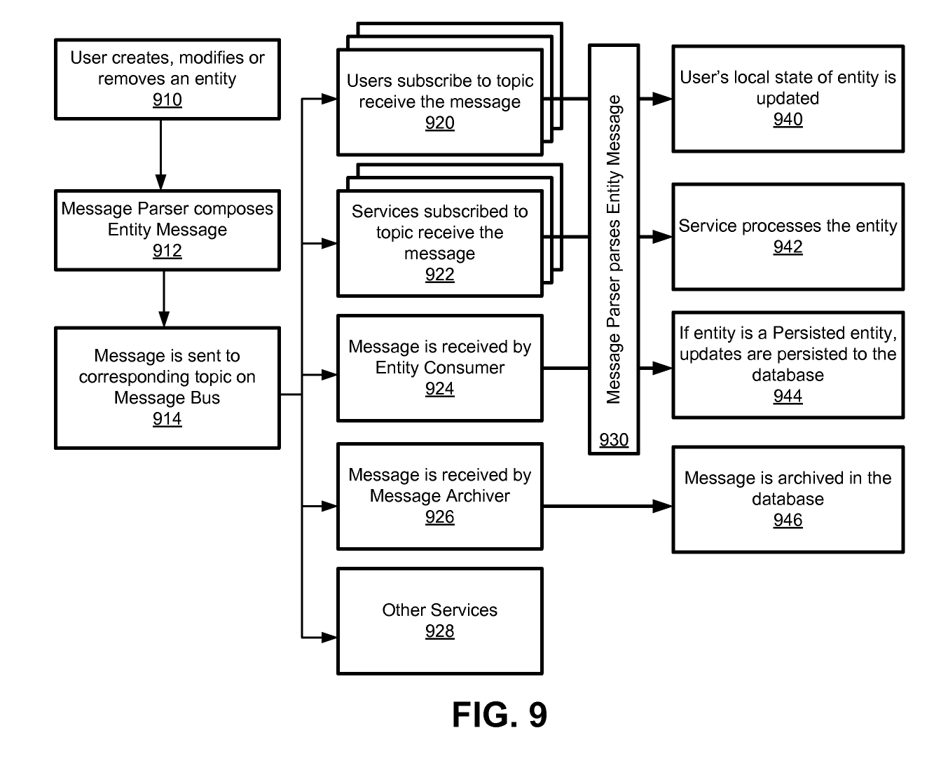

FIG. 9 shows several possible life cycles of a user created entity message 800 (FIG. 8) through the system 700 (FIG. 7). A user desiring to create, modify or remove an entity interacts with a user interface, for example, a graphical user interface on a smart phone, as shown in block 910. The user interface interacts with a message parser, which composes an entity message according to the actions directed by the user, as shown by block 912. The message parser places the entity message 800 (FIG. 8) on the message bus, for example, addressed to a topic, as shown by block 914.

Once on the message bus, the entity message 800 (FIG. 8) may be received by one or more services, as shown by blocks 920-928. Entity messages 800 (FIG. 8) received by subscribed users, subscribed topics, and/or an entity consumer may be parsed by a message parser, as shown by block 930. The message parser is a common library with methods to serialize entity objects into entity messages 800 (FIG. 8) and parse entity messages 800 (FIG. 8) into entity objects. As described above, an entity consumer is a separate service that listens to the message bus 720 and manages persisted entities, for example, creating, modifying and/or deleting persisted entities. A persisted entity is a non-transient entity whose state is maintained in memory 750, for example, in a database, for later access by users and services participating in a collaboration space.

Users subscribed to the topic of the entity message 800 (FIG. 8) may receive the entity message 800 (FIG. 8), as shown by block 920. Once parsed, the user's local state of entity is updated, as shown by block 940. Similarly, services subscribed to the topic may receive the entity message 800 (FIG. 8), as shown by block 922, and the services process the entity, as shown by block 942. The entity message 800 (FIG. 8) may be received by an entity consumer, as shown by block 924, and if the entity is a persisted entity, the entity consumer updates are persisted to the database. The entity message 800 (FIG. 8) may be received by a message archiver, as described above, as shown by block 926. The archiver stores the entity message 800 (FIG. 8) in a database, as shown by block 946. Other services may also receive the entity message 800 (FIG. 8), as shown by block 928.

The system 700 (FIG. 7) may be thought of as a framework that accepts input data that may be formatted so that data can be handled by the system in the form of entity messages 800 (FIG. 8). Third parties can create input system plug-ins to receive specific data types (entities) into the system, for example, from clients such as client devices and/or data sources, where entity messages 800 (FIG. 8) are conveyed via an entity bus to be routed and archived by the server, and then output plug-ins that allow the end user to use/process/consume the entity messages 800 (FIG. 8).

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

We claim:

1. A system for providing a content neutral virtual collaborative environment, comprising:
a plurality of clients comprising:
at least one data feed;
a first client device; and
a second client device; and
a server in communication with said plurality of clients, wherein said server comprises:
a memory;
a message bus configured to convey a plurality of entity messages, wherein each of said plurality of entity messages comprises at least one hierarchical topic and an ordered list of at least one of a group consisting of an entity object, an update entity object, and a remove entity object; and
a processor configured by the memory to perform the steps of:
converting data from at least one of said plurality of clients into said entity object;
formatting a first entity message comprising said entity object;
sending said first entity message on said message bus;
receiving a second entity message on said message bus;
processing said second entity message to create, update, and/or remove an entity object; and
storing said entity second message in said memory.

2. The system of claim 1, wherein said receiving further comprises selecting whether to receive said entity message based on said at least one hierarchical topic.

3. The system of claim 1, wherein said storing further comprises selecting whether to store said entity message based on said at least one hierarchical topic.

4. The system of claim 1, wherein:
said entity object comprises an entity identifier and a plurality of entity attributes;
said update entity object comprises at least one said entity identifier and at least one of said plurality of entity attributes; and
said remove entity object comprises at least one said entity identifier.

5. The system of claim 4, wherein each of said plurality of entity attributes comprises an attribute identifier-data pair.

6. The system of claim 4, wherein said processor is further configured by the memory to perform the steps of:
invoking an entity specific process, wherein said entity specific process may be invoked according to an entity type and/or a client;

7. The system of claim 6, wherein said entity specific process performs said converting, further comprises the steps of;
receiving, from an external data feed, an external entity comprising a first format;
converting said external entity from said first format to a converted entity comprising a second format;
wherein said entity object comprises said converted entity.

8. The system of claim 1, wherein;
said entity object comprises a collaboration space; and
said at least one hierarchical topic is associated with said collaboration space.

9. The system of claim 8, wherein said collaboration space comprises another entity object.

10. The system of claim 1, wherein said entity object comprises a map entity.

11. The system of claim 1, wherein said entity object comprises a presence entity.

12. The system of claim 1, wherein said entity object comprises a chat entity.

13. A method for a user to participate in a virtual collaborative environment, comprising a server in communication with a client device, wherein said client device comprises a memory and a processor configured by the memory to perform the steps of:
selecting a first collaboration space;
interacting with at least one entity comprising an entity object within said collaboration space;
forming a message comprising at least one hierarchical topic indicating said first collaboration space, and an ordered list of at least one of a group consisting of said entity object, an update entity object, and a remove entity object; and
sending said message to said server.

14. The method of claim 13, wherein said at least one entity comprises a second collaboration space.

15. The method of claim 13, further comprising the step of creating said at least one entity.

16. The method of claim 13, wherein interacting further comprises the steps of:
retrieving a state of said at least one entity; and
modifying said at least one entity.

17. The method of claim 13, wherein interacting further comprises the steps of:
retrieving a state of said at least one entity; and
removing said at least one entity.

18. The method of claim 13, further comprising the step of synchronizing said at least one entity with said server.
